(19) United States
(12) Patent Application Publication
(10) Pub. No.: US 2002/0121537 A1
(43) Pub. Date: Sep. 5, 2002

(54) Dispenser for rolls of web-shaped material

(76) Inventors: Tor Petterson, Rancho Palos Verdes, CA (US); Grace Petterson, Rancho Palos Verdes, CA (US)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/930,209

(22) Filed: Aug. 16, 2001

Related U.S. Application Data
(63) Continuation of application No. PCT/SE99/00306, filed on Mar. 3, 2001.

(51) Int. Cl. B26F 3/02

(52) U.S. Cl. 225/34; 225/15

(57) ABSTRACT

Dispenser for rolls of a web-shaped material, such as paper, said dispenser having space for at least two rolls (16, 17) arranged substantially horizontally, at which one space is located adjacent the outlet opening (14) and is intended for a first roll in a use position and the second space is located above the first space and is intended for a roll in standby position. A locking means (24, 25;27) is intended to keep the second roll in standby position. The first space is provided with a vertically arranged disk plate (18) having a flange (19) intended to grip around one end of the roll and keep it in use position. The disk plate is spring-loaded (23) and cooperates with the locking means in such a way that when a roll is located in place in the disk plate the locking means (24, 25;27) prevents the standby roll from falling down, but when the roll is removed from the disk plate the locking means can be released and permit the standby roll to fall down to use position in the disk plate.

### TECHNICAL FIELD

The present invention refers to a dispenser for rolls of web-shaped material, such as paper and nonwoven, said dispenser comprising a housing having at its bottom part an outlet opening for the web-shaped material and said housing having space for at least two rolls arranged substantially horizontally, at which one space is located adjacent the outlet opening and is intended for a first roll in a use position and the second space is located above the first space and is intended for a roll in a standby position, and where a locking device is intended to keep the second roll in standby position. said first space is provided with holding means for keeping the first roll in use position, said holding means is spring-loaded and cooperates with the locking means in such a way that when a roll is located in place in the first space the locking means prevents the standby roll from falling down, but when the roll is removed from the first space the locking means will be released and permit the standby roll to fall down to use position in the first space.

### BACKGROUND OF THE INVENTION

Dispensers of this kind, e g for toilet paper rolls, are intended for two or more rolls, at which one roll is in use position and the other roll(-s) is/are in standby position and is/are transferred to use position when the first roll is used up and its empty core has been removed from the dispenser.

A plurality of dispensers of this kind are previously known. Thus U.S. Pat. No. 3,865,295 discloses a toilet paper dispenser in which the rolls are each threaded on a wooden rod which runs in the dispenser wall and can be suspended in a pendulum mechanism. When changing rolls the user pushes a bar on the pendulum mechanism backwards so that on one hand the core and wooden rod of the lower roll are released and on the other hand the roll above can fall down into use position for dispensing paper. This dispenser thus requires special wooden rods for the suspension of the rolls in the dispenser.

In U.S. Pat. No. 4,383,657 there is disclosed a dispenser for two paper rolls, in which the lower roll slides freely against the bottom of the dispenser housing and a sloping rear edge thereof so that it is brought forwards to dispensing position towards a dispenser opening provided with a tearing edge. The upper roll is prevented from falling down by the upper part of a lever arm. When changing rolls the user presses on the lower part of the lever arm, which is designed as a pressure plate. The empty core is then pushed out through an opposed opening and the stop lug on the top of the lever arm is put aside so that the upper roll can fall down.

In EP-A-0,034,121 there is shown a paper dispenser for two or more rolls arranged on top of each other and where the roll which is located in use position adjacent the dispenser opening rest on a tilting plate. When the roll is used up the tilting plate can be brought to be tilted upwards by pushing a portion projecting from the dispenser opening, at which the empty core is pushed out through the dispenser opening and a locking device which keeps another roll in standby position is brought aside, at which the standby roll can fall down to use position.

CH 404 124 discloses a dispenser for two paper rolls, one of which is kept in use position between a pair of lever arms, which are springloaded towards each other so that the paper roll is squeezed therebetween. The other roll, the standby roll, is kept in place by a locking mechanism, which is activated as long as the lever arms are pressed apart by a-roll. When the empty roll is removed the lever arms will swing away from each other and release the lock mechanism, so that the standby roll will fall down into use position.

### OBJECT AND MOST IMPORTANT FEATURES OF THE INVENTION

The object of the present invention is to provide a dispenser of the above mentioned kind in which the rolls are kept in place without the need of being threaded on special rods, which is easy to use without special instructions and where the standby roll automatically will fall down into use position when the core from a used up roll is removed from the dispenser. The roll should further be kept in a correct use position in the dispenser without exerting a squeezing effect. This has according to the invention been obtained by the fact that the holding means for holding the roll in use position comprises a vertically arranged disk plate having a flange intended to grip around one end of the roll and keep it in use position.

Further features of the invention are disclosed in the dependant claims and the description.

### DESCRIPTION OF DRAWINGS

The invention will below be closer described with reference to a couple of embodiments shown in the accompanying drawings.

FIG. 1 is a perspective view of a dispenser with a part of the housing removed.

FIG. 2 shows in perspective an exploded view of the dispenser according to FIG. 1.

FIG. 3 shows in perspective an exploded view of a modified embodiment of the dispenser.

FIG. 4 is a cross section through the disk plate included in the dispenser.

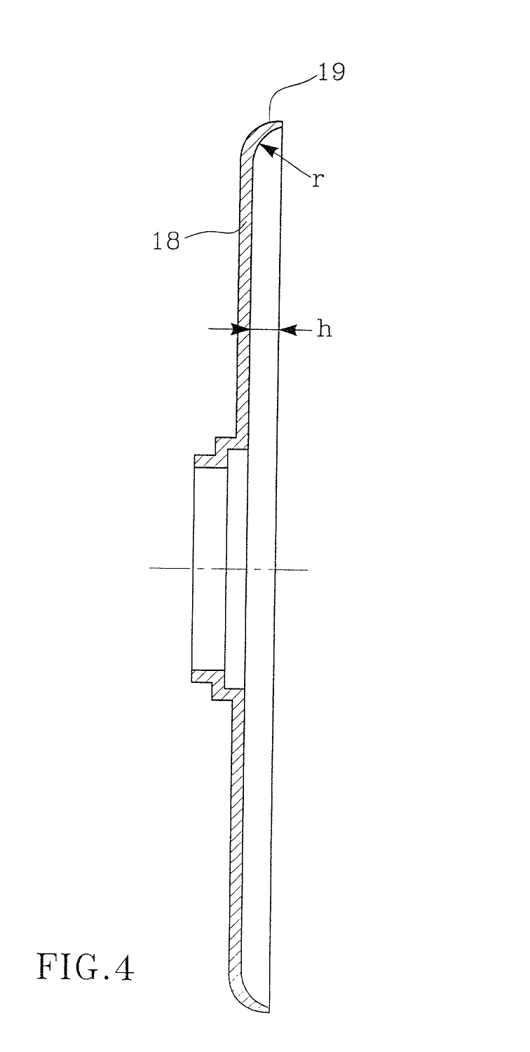

### DESCRIPTION OF EMBODIMENTS

The invention refers to a dispenser for rolls of a web-shaped material, which means all types of flexible web-shaped materials, e g plastic- or aluminum foil, nonwoven and paper. It is below mainly referred to paper although the invention is not limited to dispensers for paper. The paper can be in the form of a continuous web, at which the dispenser is provided with tearing teeth or another sharp tearing edge for cutting a certain length of the paper. The paper web can also be provided with perforations at a certain interval, in order to allow a certain length of the paper to be cut off from the roll.

At first hand such rolls are concerned where the paper is rolled up on a stiff core, but it is also possible to let the innermost windings of the paper web form a stiffened core in the roll, e g by being joined together by means of water spraying gluing or the like.

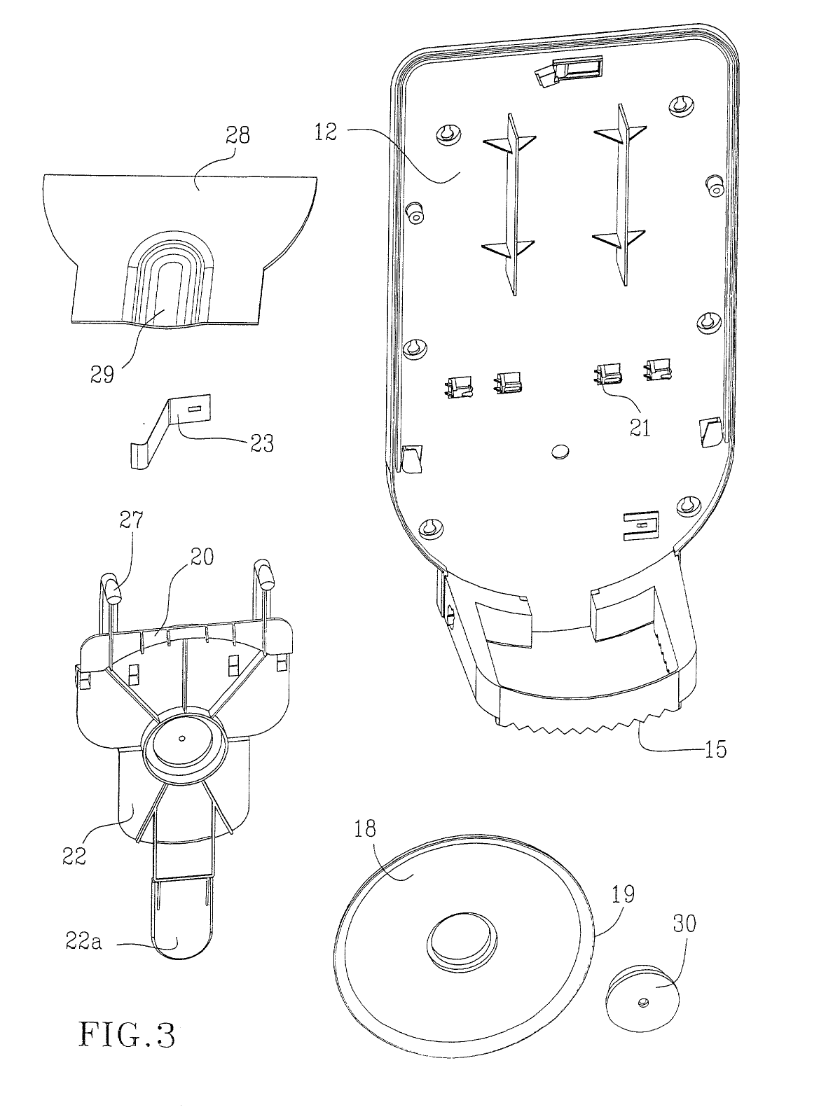

The dispenser comprises a housing which comprises an upper and a lower cover 10 and 11 and a back plate 12, which is designed as a bracket for hanging the dispenser on a wall or the like. The lower cover 10 is releasably or pivotably connected to the lower cover. The paper can by that be filled in the dispenser from above. The housing is further provided with a bottom 13, which either can be integrated with or separated from the lower cover 11 or the back plate 12. The bottom 13 is provided with a dispensing opening 14, which can have tearing teeth 15 (FIG. 3) on one or more of its edges, against which a desired length of the paper web can be torn off. The tearing means may of course be designed in many different ways. In the case the paper web is perforated the tearing means can be replaced by different types of braking- or friction means, which provide a sufficient friction against the paper web in order to make this tear along the perforation at the dispensing.

The dispenser has room for two rolls 16 and 17 arranged substantially axially horizontally, at which the first space is located adjacent the dispensing opening 14 and is intended for the roll 16 which is located in a position ready for use. The second space is located straightly above the first space and is intended for a roll 17 which is located in a standby position. In the first space there is arranged a substantially vertically suspended disk plate 18 which is provided with a flange 19 intended to grip around one edge of the roll 16 and in this way keep this in use position. The disk plate 18 is rotatably mounted to a holder 20, which is tiltably mounted on the back plate 12 to essentially horizontal axle elements 21. The holder 20 has an elongated lower portions 22 which contacts a plate spring 23 which is attached to the back plate 12. The holder 20 and the disk plate rotatably connected thereto can against the action of the plate spring 23 be tilted around the axle 21. In the embodiment shown in FIG. 3 the holder 20 is provided with an operating tongue 22a which projects through the dispensing opening in order to facilitate the removal of the empty core.

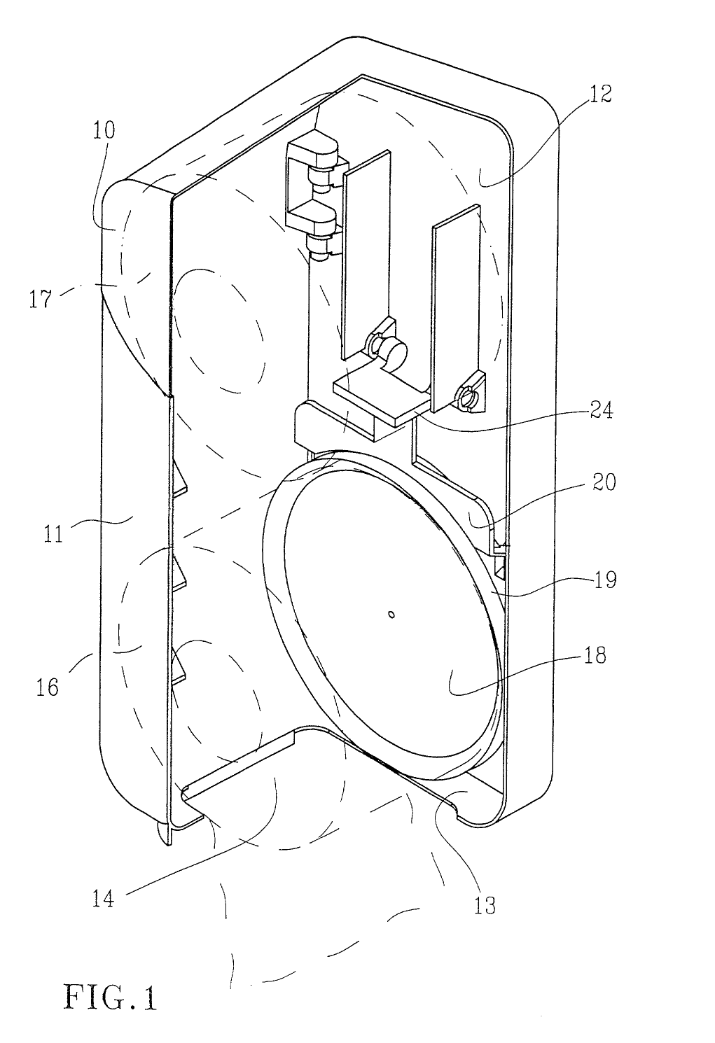

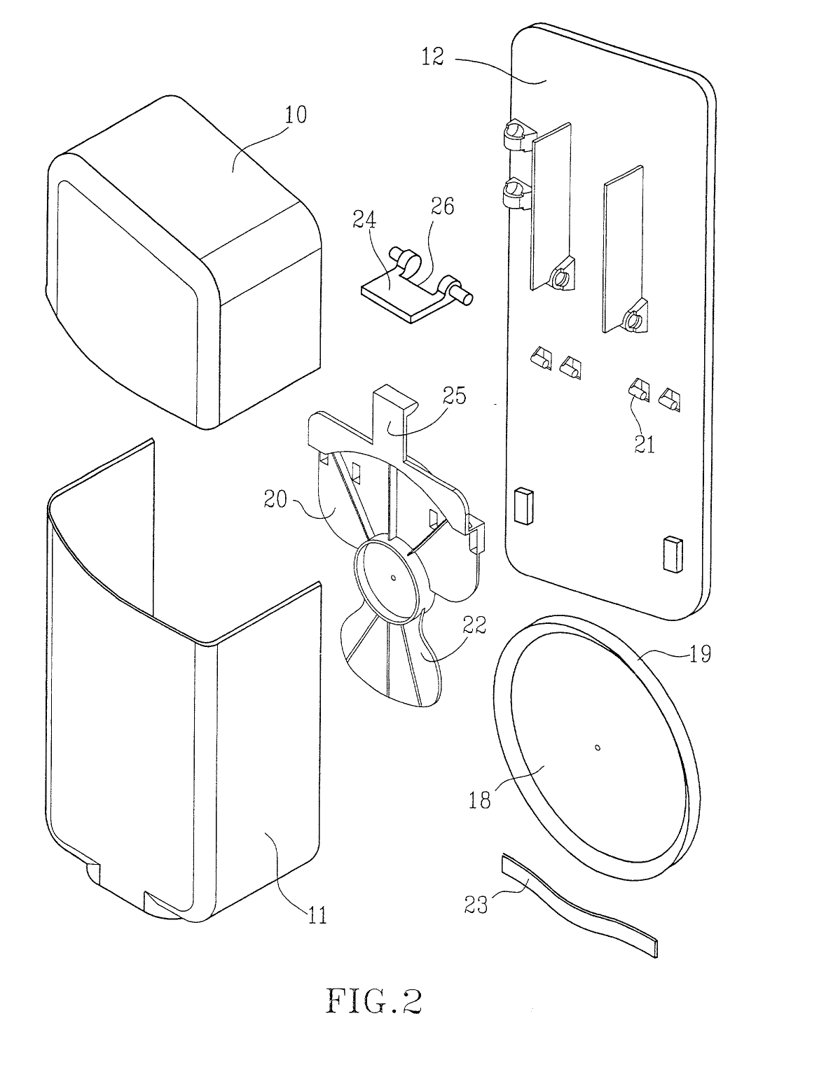

According to the embodiment shown in FIGS. 1 and 2 there is arranged a locking means in the form of a spring-loaded flap 24 between the upper and lower spaces of the dispenser, said flap will rest against an upward directed support means 25 on the holder in a position where a pressure (from a paper roll or an empty core) acts on the disk plate 18 and by that on the lower spring-loaded portions of the holder 20. The paper roll 17 which is located in standby position will rest against the flap 24 and be kept in place as long as this is supported by the support means 25. If however the pressure on the disk plate is interrupted the spring 23 will force the holder 20 and the disk plate 18 attached therein to tilt around the axle 21, so that its lower part is swung out from the back plate 12 and the upper portion is swung in towards the back plate 12. The support means 25 is then brought into a recess 26 behind the flap 24, which by the weight from the standby roll 17 folds down at which the roll automatically falls down to use position, where it rests in the disk plate 18. When the roll lands up in place in the disk plate 18 it will force this and the holder 20 to tilt back against the action of the spring 23, at which the spring-loaded flap 24 returns to its position where it can act as locking means for a new roll that is placed in the upper standby space of the dispenser.

Brake- or friction means in the form of ribs or the like may be arranged on the inside of the lower and/or upper cover 10 in order to brake the movement of the roll on its way from the standby position to use position and prevent it from falling down directly with its whole weight.

According to the embodiment shown in FIG. 3 the locking means which keeps the standby roll in place consists of a pair of supporting pins 27, which form an integrated part with the holder 20. The standby roll will be supported by these supporting pins 27 as long as a roll or empty core is located in the disk plate 18, but as soon as the empty core is removed the disk plate and the holder 20 actuated thereby will, in a corresponding way as described above, tilt around the axle 21, at which the supporting pins 27 will be brought in the direction towards the back plate 12 and out of engagement with the standby roll, which then falls down to use position in the disk plate 18.

The design of the spring 23 differs also from what is shown in FIGS. 1 and 2, however the function is the same. The disk plate 18 is attached to the holder 20 by means of a threaded cap 30. In FIG. 3 there is also shown a plate 28 intended to be fastened on the inside of the lower cover 11 just opposite the disk plate 18. The plate 28 has at its lower portion a groove-shaped recess 29, in which the empty core or an almost used up roll with only a few paper windings left will end up. By that the removal of the core is facilitated. On the other hand the removal of a roll where only so much paper is left that the roll has not yet slid into the recess is obstructed. The plate 28, which for example is of rustless steel, also reduces the friction at the rotation of the roll when unwinding the paper.

The design of the disk plate 18 is of a certain importance and thus the height and radius of curvature of the flange 19 should be such dimensioned that on one hand a safe holding of the roll is achieved and on the other hand permitting the standby roll to automatically fall down into place in the disk plate. The height of the flange 19 should be between 2-20 mm, preferably 5-15 mm and the radius of curvature should be between 2-20 mm, preferably 5-15 mm.

The dispenser according to the invention has a number of advantages such as:

it has a great capacity, i e it can store much paper, which means a less frequent filling,

it has a safe and simple mechanism with few parts,

it is simple to use and load with more paper,

it is possible to remove a not completely empty almost used up roll with only a few windings left from use position, in order to enable replacement for a new roll, at the same time as it is not possible to remove a roll containing a greater number of windings.

The invention is of course not delimited to the shown embodiments but a plurality of modifications are possible within the scope of the claims. Thus it is possible to arrange two opposite disk plates 18 between which the roll 16 is placed, at which the second disk plate is rotatably mounted in the lower cover 11. The disk plate(-s) can also be fixed, i e non-rotatable, at which the roll rotates against the inside of the disk(-s). The locking means which keeps the standby roll in place may also be designed in many different ways. Another possibility is to design the covers 10,11 exchangeable and with different depths in order to be adapted to rolls of different widths. The covers 10, 11 may also be provided with transparent sighting notches to make it possible to see from the outside whether a standby roll is in place and how much is left of the roll in use position. The covers may of course wholly be of a transparent material, at which the sighting notches are superfluous.

1. Dispenser for rolls of a web-shaped material, such as paper and nonwoven, said dispenser comprising a housing (10,11,12,13) having at its bottom part an outlet opening (14) for the web-shaped material and said housing having space for at least two rolls (16,17) arranged substantially horizontally, at which one space is located adjacent the outlet opening (14) and is intended for a first roll in a use position and the second space is located above the first space and is intended for a roll in standby position, and where a locking means (24,25;27) is intended to keep the second roll in standby position, said first space is provided with holding means (18) for keeping the first roll in use position, said holding means is spring-loaded (23) and cooperates with the locking means in such a way that when a roll is located in place in the first space the locking means (24,25;27) prevents the standby roll from falling down, but when the roll is removed from the first space the locking means will be released and permit the standby roll to fall down to use position in the first space, characterized in the the holding means comprises a vertically arranged disk plate (18) having a flange (19) intended to grip around one end of the roll and keep it in use position.

2. Dispenser as claimed in claim 1,
characterized in
that the disk plate (18) is rotatable in the housing (10,11,12) around one or more essentially horizontal axle elements (21) substantially perpendicular to the axial direction of the roll (16) and is spring loaded (23) in such a way that in unloaded position, when there is no roll in place in the disk plate, this will take a position so that the locking means (24,25;27) is inactive, but when a roll comes into place in the disk plate this will against the action of the spring (23) be rotated to a position where the locking means (24,25;27) is activated and can keep a standby roll (17) in the second space.

3. Dispenser as claimed in claim 1,
characterized in
that the flange (19) of the disk plate has a height between 2 and 20 mm preferably between 5 and 15 mm and that the radius of curvature (r) of the flange is between 2 and 20 mm preferably between 5 and 15 mm.

4. Dispenser as claimed in claim 1,
characterized in
that the disk plate (18) is mounted in a holder (20) which is rotatably mounted in the housing around said substantially horizontal axle elements (21) and that the holder is provided with at least one of said locking means (25;27).

5. Dispenser as claimed in claim 5,
characterized in
that the disk plate (18) is rotatably mounted in the holder (20).

6. Dispenser as claimed in claim 1,
characterized in
that in the housing (11) just opposite the disk plate (18) there is arranged a smooth friction reducing member (28) provided with a recess (29) in which an empty core from a used up roll or an almost used up roll with only a few windings left can slide into, at which the removal of the empty or almost used up roll is facilitated.
